(19) United States
(12) Patent Application Publication
(10) Pub. No.: US 2016/0073173 A1
(43) Pub. Date: Mar. 10, 2016

(54) VIDEO STREAM PROVIDING METHOD AND SYSTEM AND RELAY APPARATUS

(71) Applicant: SAMSUNG SDS CO., LTD., Seoul (KR)

(72) Inventors: Young Tai NA, Seongnam-si (KR); Soo Hwan PARK, Seoul (KR); Bo Ri OH, Seoul (KR)

(73) Assignee: SAMSUNG SDS CO., LTD., Seoul (KR)

(21) Appl. No.: 14/529,392

(22) Filed: Oct. 31, 2014

(30) Foreign Application Priority Data
Sep. 5, 2014 (KR) 10-2014-0119115

(51) Int. Cl. H04N 21/647; H04N 21/61

(52) U.S. Cl. CPC H04N 21/64738; H04N 21/64707; H04N 21/6125

(57) ABSTRACT

A method of providing a video stream which includes different video stream data for each of a plurality of layers is provided. The method includes: receiving from a transmitting apparatus a maximum transmittable layer level determined based on a state of a first network; receiving from a first receiving terminal a first maximum receivable layer level determined based on a state of a 2ath network; receiving from a second receiving terminal a second maximum receivable layer level determined based on a state of a 2bth network; and relaying the video stream using the maximum transmittable layer level, the first maximum receivable layer level and the second maximum receivable layer level.

This application claims priority from Korean Patent Application No. 10-2014-0119115 filed on Sep. 5, 2014 in the Korean Intellectual Property Office, the disclosure of which is incorporated herein by reference in its entirety.

### BACKGROUND OF THE INVENTION

1. Field of the Invention

The present invention relates to a video stream providing method and system and a relay apparatus, and more particularly, to a video stream providing method and system which provide a video steam including different video stream data for each of a plurality of layers and a relay apparatus.

2. Description of the Related Art

The development of mobile devices and mobile networks is increasing the popularity of a mobile Voice over Internet Protocol (VoIP) service that allows many users to exchange a video in real time using mobile devices. In addition, a real-time streaming service (e.g., a live professional baseball game) targeted for mobile devices is gaining popularity.

To transmit a video stream to many users, scalable video codec (SVC) may be used. The SVC such as H.264 SVC may form one video stream using a plurality of layers and transmit the video stream accordingly.

In video stream providing technology using the SVC, a transmitting apparatus transmits one video stream to a relay apparatus, and a plurality of receiving terminals receive the video stream by accessing the relay apparatus.

To provide a video stream using a plurality of layers as in the SVC, the relay apparatus should perform a process such as filtering.

Specifically, the relay apparatus may perform a filtering process in order to select a transmission layer for each receiving terminal. For the filtering process, the relay apparatus should parse all or almost all video stream data composed of a plurality of layers and received from the transmitting apparatus.

### SUMMARY OF THE INVENTION

Aspects of the present invention provide a video stream providing method and system in which a relay apparatus can eliminate or reduce the operation cost required for, e.g., parsing in a service that provides a video stream including different video stream data for each of a plurality of layers, and a relay apparatus.

Aspects of the present invention also provide a video stream providing method and system which can improve the performance of a relay apparatus in a service that provides a video stream including different video stream data for each of a plurality of layers, and a relay apparatus.

However, aspects of the present invention are not restricted to the one set forth herein. The above and other aspects of the present invention will become more apparent to one of ordinary skill in the art to which the present invention pertains by referencing the detailed description of the present invention given below.

According to an aspect of the present invention, there is provided a method of providing a video stream which includes different video stream data for each of a plurality of layers. The method includes: receiving from a transmitting apparatus a maximum transmittable layer level determined based on a state of a first network; receiving from a first receiving terminal a first maximum receivable layer level determined based on a state of a 2a-th network; receiving from a second receiving terminal a second maximum receivable layer level determined based on a state of a 2b-th network; and relaying the video stream using the maximum transmittable layer level, the first maximum receivable layer level and the second maximum receivable layer level.

According to another aspect of the present invention, there is provided a system for providing a video stream which includes different video stream data for each of a plurality of layers. The system includes: a relay apparatus which provides a communication channel for each of the layers; and a transmitting apparatus which transmits to the relay apparatus a maximum transmittable layer level determined based on a state of a first network and transmits the video stream to the relay apparatus, wherein the relay apparatus includes: a receivable layer level reception unit which receives from a first receiving terminal a first maximum receivable layer level determined based on a state of a 2a-th network and receives from a second receiving terminal a second maximum receivable layer level determined based on a state of a 2b-th network; and a video stream relay unit which relays the video stream using the maximum transmittable layer level, the first maximum receivable layer level and the second maximum receivable layer level.

According to another aspect of the present invention, there is provided a relay apparatus for providing a video stream which includes different video stream data for each of a plurality of layers. The relay apparatus includes: a transmittable layer level reception unit which receives from a transmitting apparatus a maximum transmittable layer level determined based on a state of a first network; a receivable layer level reception unit which receives from a first receiving terminal a first maximum receivable layer level determined based on a state of a 2a-th network and receives from a second receiving terminal a second maximum receivable layer level determined based on a state of a 2b-th network; and a video stream relay unit which relays the video stream using the maximum transmittable layer level, the first maximum receivable layer level and the second maximum receivable layer level.

According to another aspect of the present invention, there is provided a computer program combined with hardware and stored on a medium to execute a method of providing a video stream which includes different video stream data for each of a plurality of layers. The method includes: receiving from a transmitting apparatus a maximum transmittable layer level determined based on a state of a first network; receiving from a first receiving terminal a first maximum receivable layer level determined based on a state of a 2a-th network; receiving from a second receiving terminal a second maximum receivable layer level determined based on a state of a 2b-th network; and relaying the video stream using the maximum transmittable layer level, the first maximum receivable layer level and the second maximum receivable layer level.

It is noted that one or more of the elements of the foregoing embodiments may be implemented via CPU or hardware processor.

### BRIEF DESCRIPTION OF THE DRAWINGS

The above and other aspects and features of the present invention will become more apparent by describing in detail exemplary embodiments thereof with reference to the attached drawings, in which:

FIG. 1 illustrates the configuration of a video stream providing system according to an embodiment of the present invention;

FIGS. 2 and 3 illustrate a method of providing a video stream of a different quality to each receiving terminal using a plurality of layers in scalable video codec (SVC) technology;

FIG. 4 illustrates an example of a communication channel provided for each layer by a relay apparatus;

FIG. 5 is a flowchart illustrating a video stream providing method according to another embodiment of the present invention;

FIG. 6 illustrates a first network;

FIG. 7 illustrates a second network;

FIG. 8 is a flowchart illustrating a specific example of the video stream providing method of FIG. 5;

FIG. 9 is a block diagram of a relay apparatus according to another embodiment of the present invention; and

FIG. 10 illustrates another configuration of the relay apparatus of FIG. 9.

### DETAILED DESCRIPTION OF THE INVENTION

The present invention will now be described more fully with reference to the accompanying drawings, in which exemplary embodiments of the invention are shown. Advantages and features of the present invention and methods of accomplishing the same may be understood more readily by reference to the following detailed description of exemplary embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated components, steps, operations, and/or elements, but do not preclude the presence or addition of one or more other components, steps, operations, elements, and/or groups thereof.

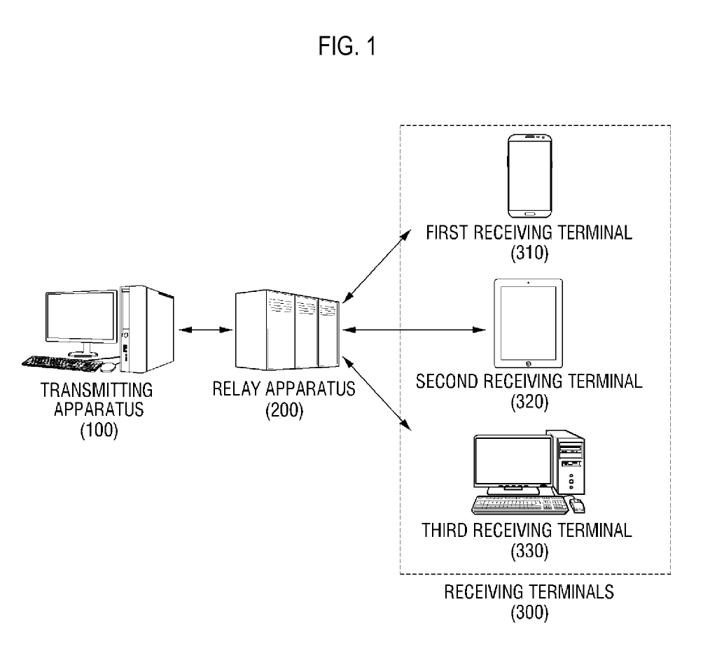

FIG. 1 illustrates the configuration of a video stream providing system according to an embodiment of the present invention.

Referring to FIG. 1, the video stream providing system according to the current embodiment may include a transmitting apparatus 100, a relay apparatus 200, and a plurality of receiving terminals 300 which receive a video stream.

The transmitting apparatus 100 transmits a video stream to the relay apparatus 200.

The relay apparatus 200 may transmit the video stream received from the transmitting apparatus 100 to the receiving terminals 300.

That is, the transmitting apparatus 100 may transmit the video stream to the receiving terminals 300 via the relay apparatus 200.

Each (310, 320, 330) of the receiving terminals 300 may receive a video stream through the relay apparatus 200.

The video stream providing system according to the current embodiment can also be applied in a case where there is only one receiving terminal.

The video stream providing system according to the current embodiment can be used more effectively in a service (such as scalable video codec (SVC)) that provides a video stream using a plurality of layers 10.

That is, the video stream providing system according to the current embodiment can be applied more effectively to a service that provides a video stream using the SVC than to a video streaming service that provides a video stream of a quality selected by a user from low quality, medium quality, and high quality.

In the video streaming service that provides a video stream of a quality selected by a user from low quality, medium quality and high quality, high-quality video stream data is provided to a user when the user selects high quality, and a video is often interrupted in a poor network environment.

On the other hand, in the video stream providing system according to the current embodiment, the quality of a video is not selected by a user. Instead, the video stream providing system according to the current embodiment provides a video stream by adjusting the quality of the video stream periodically or in real time in view of the network environment. Therefore, even if the quality of the video stream is reduced, the video stream is hardly interrupted.

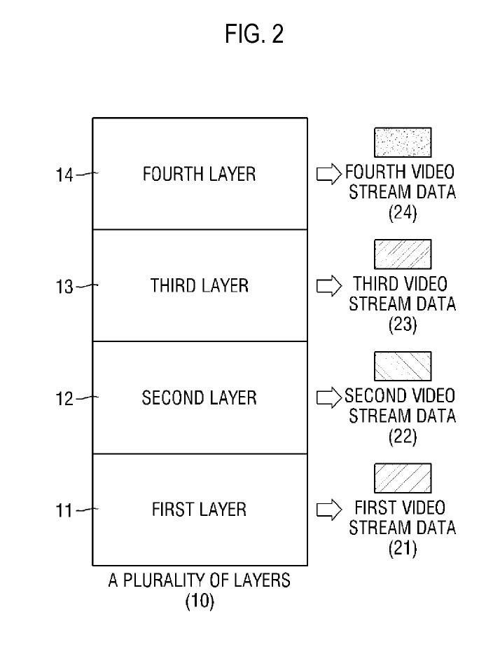

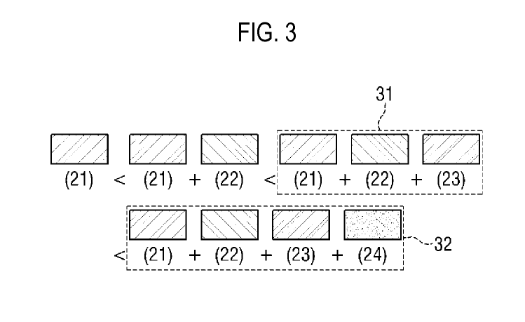

FIGS. 2 and 3 illustrate a method of providing a video stream of a different quality to each receiving terminal using a plurality of layers 10 in SVC technology.

The layers 10 may include two to eight or more layers. In FIGS. 2 and 3, a case where the layers 10 include a first layer 11, a second layer 12, a third layer 13 and a fourth layer 14 will be described as an example.

The transmitting apparatus 100 transmits a video stream to a receiving terminal through the relay apparatus 200 by using the first through fourth layers 11 through 14.

The receiving terminal may receive first video stream data 21 using the first layer 11. Alternatively, the receiving terminal may receive the first video stream data 21 and second video stream data 22 using the first layer 11 and the second layer 12.

Alternatively, the receiving terminal may receive the first video stream data 21, the second video stream data 22, and third video stream data 23 using the first layer 11, the second layer 12, and the third layer 13. Alternatively, the receiving terminal may receive the first video stream 21, the second video stream 22, the third video stream 23, and fourth video stream data 24 using the first layer 11, the second layer 12, the third layer 13, and the fourth layer 14.

Referring to FIG. 3, a receiving terminal is provided with a higher-quality video when receiving the first video stream data 21 and the second video stream data 22 using the first layer 11 and the second layer 12 than when receiving only the first video stream data 21 using the first layer 11.

In addition, the receiving terminal is provided with a higher-quality video when receiving the first video stream data 21, the second video stream data 22, and the third video stream data 23 using the first layer 11, the second layer 12, and the third layer 13 than when receiving the first video stream data 21 and the second video stream data 22 using the first layer 11 and the second layer 12.

Further, the receiving terminal is provided with a higher-quality video when receiving the first video stream data 21, the second video stream data 22, the third video stream data 23, and the fourth video stream data 24 using the first layer 11, the second layer 12, the third layer 13, and the fourth layer 14 than when receiving the first video stream data 21, the second video stream data 22, and the third video stream data 23 using the first layer 11, the second layer 12, and the third layer 13.

That is, the receiving terminal may be provided with a higher-quality video when receiving more video stream data using layers higher than the first layer 11 than when receiving only the first video stream data 21 using the first layer 11.

Specifically, the first video stream data 21, the second video stream data 22, the third video stream data 23 and the fourth video stream data 24 are generated as a video and encoded using the SVC technology. That is, the sum of the first video stream data 21, the second video stream data 22, the third video stream data 23 and the fourth video stream data 24 may be the same as data obtained by encoding the video to the highest resolution using the SVC technology. The video can be reproduced using the first video stream data 21 only. In this case, however, the quality (e.g., resolution) of the video is reduced. The more video stream data received using upper layers, the closer to the video quality of the highest resolution.

The phrase ‘transmit or receive a video stream at an nth layer level’ used throughout the present specification may denote ‘transmit or receive a video stream using an nth layer and layers lower than the nth layer.”

That is, if the transmitting apparatus 100 transmits a video stream 31 to a first receiving terminal 310 at a third layer level via the relay apparatus 200, it means that the transmitting apparatus 100 transmits the first video stream data 21 using the first layer 11, the second video stream data 22 using the second layer 12, and the third video stream data 23 using the third layer 13.

In another example, if the transmitting apparatus 100 transmits a video stream 32 to the first receiving terminal 310 at a fourth layer level via the relay apparatus 200, it means that the transmitting apparatus 100 transmits the first video stream data 21 using the first layer 11, the second video stream data 22 using the second layer 12, the third video stream data 23 using the third layer 13, and the fourth video stream data 24 using the fourth layer 14.

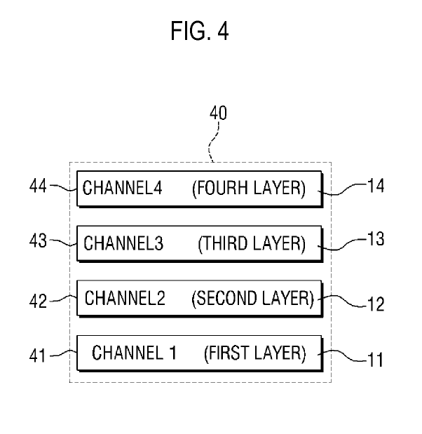

FIG. 4 illustrates an example of a communication channel provided for each layer by the relay apparatus 200.

The relay apparatus 200 may set a channel 40 corresponding to each layer.

Referring to FIG. 4, the relay apparatus 200 provides a first channel 41 which is a communication channel used to transmit the first video stream data 21 using the first layer 11. In addition, the relay apparatus 200 provides a second channel 42 which is a communication channel used to transmit the second video stream data 22 using the second layer 12.

Further, the relay apparatus 200 provides a third channel 43 which is a communication channel used to transmit the third video stream data 23 using the third layer 13. The relay apparatus 200 also provides a fourth channel 44 which is a communication channel used to transmit the fourth video stream data 24 using the fourth layer 14.

For example, when the transmitting apparatus 100 provides a video stream to a receiving terminal at a third layer level through the relay apparatus 200, the relay apparatus 200 relays the video stream through the first channel 41, the second channel 42, and the third channel 43.

The operation of the video stream providing system according to the current embodiment can be understood from a video stream providing method according to another embodiment of the present invention.

Likewise, the description of FIGS. 1 through 4 can be applied to the video stream providing method according to the embodiment of the present invention.

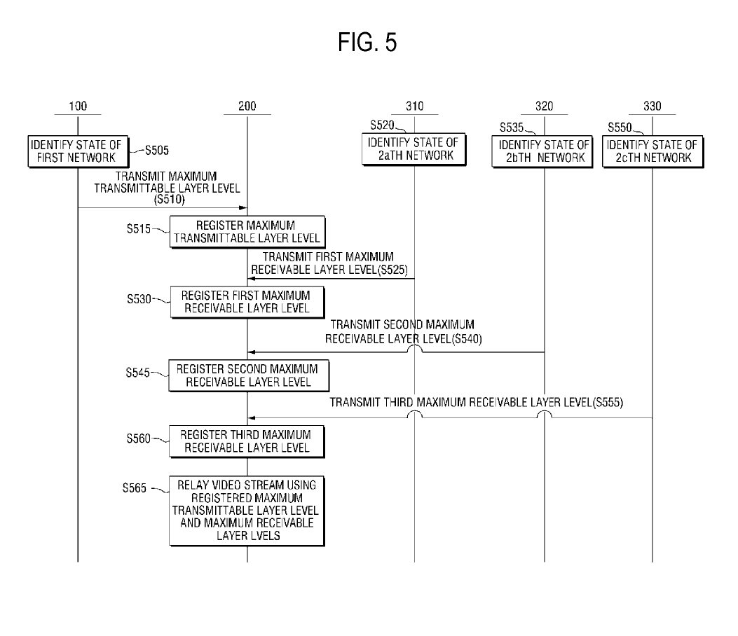

FIG. 5 is a flowchart illustrating a video stream providing method according to another embodiment of the present invention.

To help understand the present invention, a case where there exists a first receiving terminal 310, a second receiving terminal 320, and a third receiving terminal 330 will be described in FIG. 5 as an example. However, the scope of application of the present invention is not limited to the case where there are three receiving terminals. The present invention can also be applied to a case where there is one receiving terminal, a case where there are two receiving terminals, and a case where there are three or more receiving terminals.

Referring to FIG. 5, a transmitting apparatus 100 identifies the state of a first network 61 (operation S505).

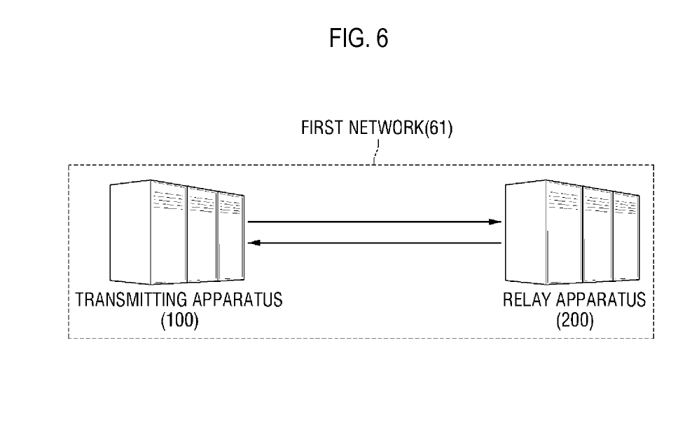

The first network 61 will now be described with reference to FIG. 6.

FIG. 6 illustrates the first network 61.

Referring to FIG. 6, the first network 61 is a network between the transmitting apparatus 100 and a relay apparatus 200. The transmitting apparatus 100 may identify the state of the first network 61 using at least one of packet loss, jitter, and delay in the first network 61.

Alternatively, the state of the first network 61 can be identified based on various performance factors including hardware specifications of the transmitting apparatus 100 and the relay apparatus 200, bandwidth, and data processing load.

Referring back to FIG. 5, the transmitting apparatus 100 determines a maximum transmittable layer level for a video stream based on the identified state of the first network 61. The transmitting apparatus 100 transmits the determined maximum transmittable layer level to the relay apparatus 200 (operation S510).

The relay apparatus 200 receives the maximum transmittable layer level from the transmitting apparatus 100 and registers the maximum transmittable layer level of the transmitting apparatus 100 (operation S515).

The first receiving terminal 310 identifies the state of a 2ath network 71a (operation S520). The second receiving terminal 320 identifies the state of a 2bth network 71b (operation S535). The third terminal 330 identifies the state of a 2cth network 71c (operation S550).

The 2ath network 71a, the 2bth network 71b, and the 2cth network 71c are included in a second network 71.

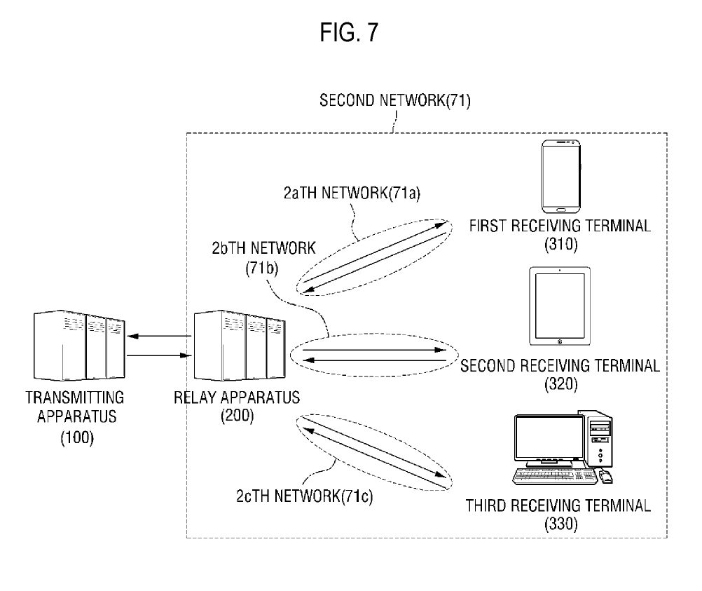

The second network 71 and the 2ath network 71a, the 2bth network 71b and the 2cth network 71c included in the second network 71 will now be described with reference to FIGS. 7.

FIG. 7 illustrates the second network 71.

Referring to FIG. 7, the second network 71 is a network between the relay apparatus 200 and receiving terminals.

In FIG. 7, the second network 71 includes the 2ath network 71a, the 2bth network 71b, and the 2cth network 71c.

Specifically, a network between the relay apparatus 200 and the first receiving terminal 310 is the 2ath network 71a. In addition, a network between the relay apparatus 200 and the second receiving terminal 320 is the 2bth network 71b. A network between the relay apparatus 200 and the third receiving terminal 330 is the 2cth network 71c.

Each receiving terminal can identify the state information of the second network 71 (the 2ath network 71a, the 2bth network 71b or the 2cth network 71c) using at least one of packet loss, jitter, and delay in the second network 71.

Alternatively, the state of the second network 71 can be identified based on various performance factors including hardware specifications of the transmitting apparatus 100 and the relay apparatus 200, bandwidth, and data processing load.

Specifically, the first receiving terminal 310 may identify the state of the 2ath network 71a in view of packet loss, jitter, delay, hardware specifications, bandwidth and/or data processing load in the 2ath network 71a between the relay apparatus 200 and the first receiving terminal 310.

The second receiving terminal 320 may identify the state of the 2bth network 71b in view of packet loss, jitter, delay, hardware specifications, bandwidth and/or data processing load in the 2bth network 71b between the relay apparatus 200 and the second receiving terminal 320.

Likewise, the third receiving terminal 330 may identify the state of the 2cth network 71c in view of packet loss, jitter, delay, hardware specifications, bandwidth and/or data processing load in the 2cth network 71c between the relay apparatus 200 and the third receiving terminal 330.

Referring back to FIG. 5, the first receiving terminal 310 determines a first maximum receivable layer level, at which the first receiving terminal 310 can receive a video stream, using the identified state of the 2ath network 71a. The first receiving terminal 310 transmits the determined first maximum receivable layer level to the relay apparatus 200 (operation S525).

The relay apparatus 200 registers the first maximum receivable layer level of the first receiving terminal 310 (operation S530).

The second receiving terminal 320 determines a second maximum receivable layer level, at which the second receiving terminal 320 can receive a video stream, using the identified state of the 2bth network 71b. The second receiving terminal 320 transmits the determined second maximum receivable layer level to the relay apparatus 200 (operation S540).

The relay apparatus 200 registers the second maximum receivable layer level of the second receiving terminal 320 (operation S545).

The third receiving terminal 330 determines a third maximum receivable layer level, at which the third receiving terminal 330 can receive a video stream, using the identified state of the 2cth network 71c. The third receiving terminal 330 transmits the determined third maximum receivable layer level to the relay apparatus 200 (operation S555).

The relay apparatus 200 registers the third maximum receivable layer level of the third receiving terminal 330 (operation S560).

The relay apparatus 200 relays a video stream using the registered maximum transmittable layer level, the registered first maximum receivable layer level, the registered second maximum receivable layer level, and the registered third maximum receivable layer level (operation S565).

Specifically, if the registered maximum transmittable layer level is equal to or higher than the first maximum receivable layer level, the second maximum receivable layer level, and the third maximum receivable layer level, the relay apparatus 200 relays a video stream to the first receiving terminal 310 at the first maximum receivable layer level. In addition, the relay apparatus 200 relays a video stream to the second receiving terminal 320 at the second maximum receivable layer level. The relay apparatus 200 also relays a video stream to the third receiving terminal 330 at the third maximum receivable layer level.

In another example, if a receiving terminal has a maximum receivable layer level higher than the maximum transmittable layer level, the relay apparatus 200 relays a video stream to the receiving terminal at the maximum transmittable layer level.

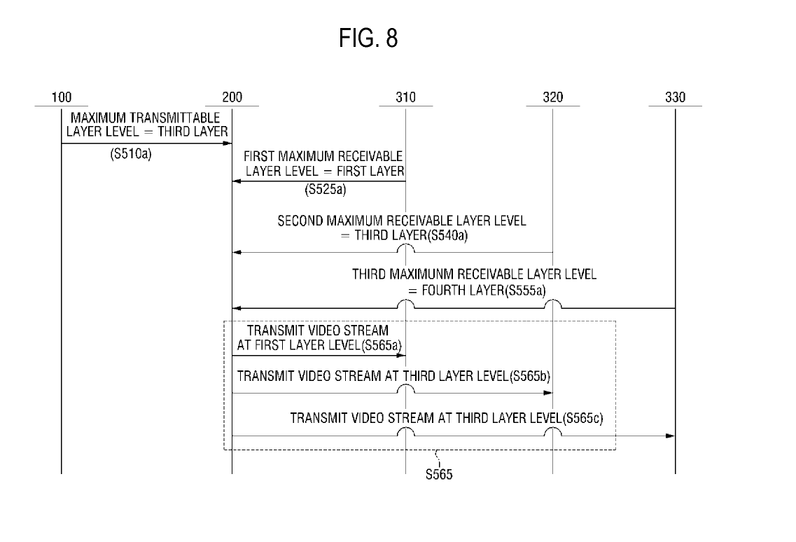

A more specific example will now be described with reference to FIG. 8.

FIG. 8 is a flowchart illustrating a specific example of the video stream providing method of FIG. 5.

Referring to FIG. 8 together with FIG. 5, the maximum transmittable layer level of the transmitting apparatus 100 is a third layer (operation S510a), and the first maximum receivable layer level of the first receiving terminal 310 is a first layer (operation S525a).

The second maximum receivable layer level of the second receiving terminal 320 is the third layer (operation S540a).

The relay apparatus 200 relays a video stream using the maximum transmittable layer level (the third layer), the first maximum receivable layer level (the first layer), the second maximum receivable layer level (the third layer), and the third maximum receivable layer level (a fourth layer).

That is, the relay apparatus 200 relays a video stream at the first maximum receivable layer level (the first layer) and the second maximum receivable layer level (the third layer) equal to or lower than the maximum transmittable layer level (the third layer).

Specifically, the relay apparatus 200 relays a video stream to the first receiving terminal 310 at a first layer level (operation S565a).

In addition, the relay apparatus 200 relays a video stream to the third receiving terminal 330 at a third layer level (operation S565b). That is, the relay apparatus 200 relays a video stream to the third receiving terminal 330 using the first layer, a second layer, and the third layer.

However, since the third maximum receivable layer level (the fourth layer) of the third receiving terminal 330 exceeds the maximum transmittable layer level (the third layer), the relay apparatus 200 relays a video stream to the third receiving terminal 330 at the maximum transmittable layer level.

That is, the relay apparatus 200 relays a video stream to the third receiving terminal 330 at the third layer level (operation S565c).

If the third maximum receivable layer level of the third receiving terminal 330 is the third layer and if the maximum transmittable layer level is the fourth layer, the relay apparatus 200 relays a video stream to the third receiving terminal 330 at the third layer level. Since all receiving terminals do not require a level higher than the third layer, the fourth layer is not used. Therefore, the relay apparatus 200 may temporarily not use a fourth communication channel allocated to the fourth layer by dropping the fourth communication channel.

Alternatively, since the maximum transmittable layer level does not need to be four in this case, the transmitting apparatus 100 may transmit to the relay apparatus 200 the maximum transmittable layer level determined to be the third layer level which is highest among the maximum receivable layer levels of the receiving terminals.

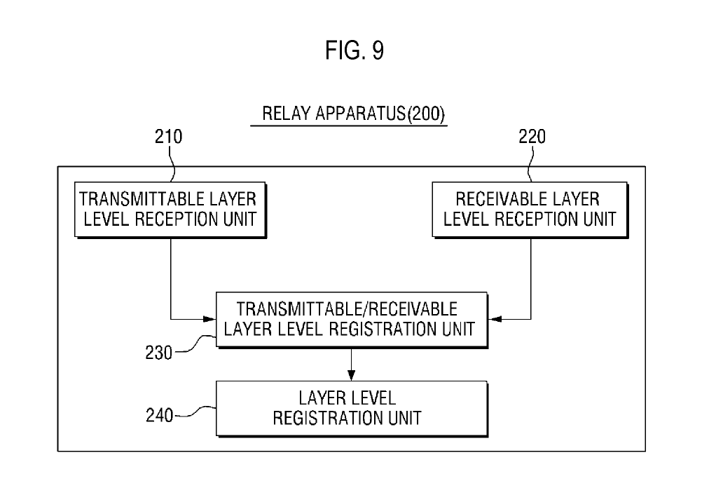

FIG. 9 is a block diagram of a relay apparatus 200 according to another embodiment of the present invention.

Referring to FIG. 9, the relay apparatus 200 according to the current embodiment includes a transmittable layer level reception unit 210, a receivable layer level reception unit 220, a transmittable/receivable layer level registration unit 230, and a video stream relay unit 240.

The transmittable layer level reception unit 210 may receive a maximum transmittable layer level of a transmitting apparatus 100 from the transmitting apparatus 100.

The receivable layer level reception unit 220 may receive from the transmitting apparatus 100 a maximum receivable layer level of each terminal.

The transmittable/receivable layer level registration unit 230 registers the maximum transmittable layer level received from the transmittable layer level reception unit 210. In addition, the transmittable/receivable layer level registration unit 230 registers the maximum receivable layer level of each terminal.

The video stream relay unit 240 relays a video stream to each terminal using the maximum transmittable layer level and the maximum receivable layer level of each terminal which are registered in the transmittable/receivable layer level registration unit 230.

More details about the relay apparatus 200 according to the current embodiment can be understood from the video steam providing system and method described above with reference to FIGS. 1 through 8.

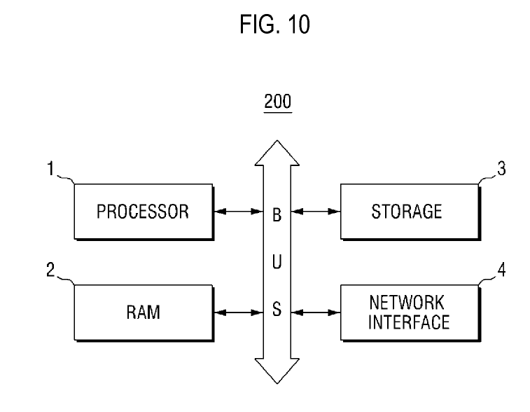

FIG. 10 illustrates another configuration of the relay apparatus 200 of FIG. 9.

The relay apparatus 200 can also be configured as illustrated in FIG. 10.

The relay apparatus 200 may include a processor 1 which executes a command, a memory 2 such as a random access memory (RAM), a storage 3 which stores program data, a network interface 4 for data exchange with an external device, and a data bus 5 which is connected to the processor 1 and the memory 2 to serve as a data transfer path.

According to an embodiment of the present invention, the relay apparatus 200 can eliminate or reduce the operation cost required for, e.g., parsing in a service that provides a video stream including different video stream data for each of a plurality of layers.

That is, the conventional art requires a process such as filtering in order to provide a video stream including different video stream data for each of a plurality of layers. For the filtering process, all data or almost all data need to be parsed. However, the present invention does not require parsing or requires parsing only for channels. Therefore, the present invention can reduce the operation cost required for, e.g., parsing and improve the performance of the relay apparatus 200.

Each component of FIG. 9 means, but is not limited to, a software component or a hardware component such as a Field Programmable Gate Array (FPGA) or Application Specific Integrated Circuit (ASIC). A component may advantageously be configured to reside on the addressable storage medium and configured to execute on one or more processors. The functionality provided for in the components may be combined into fewer components or further separated into additional components.

Embodiments of the present invention provide at least one of the following advantages.

According to an embodiment of the present invention, a relay apparatus can eliminate or reduce the operation cost required for, e.g., parsing in a service that provides a video stream including different video stream data for each of a plurality of layers.

In addition, it is possible to improve the performance of a relay apparatus in a service that provides a video stream including different video stream data for each of a plurality of layers.

However, the effects of the present invention are not restricted to the one set forth herein. The above and other effects of the present invention will become more apparent to one of daily skill in the art to which the present invention pertains by referencing the claims.

While the present invention has been particularly shown and described with reference to exemplary embodiments thereof, it will be understood by those of ordinary skill in the art that various changes in form and detail may be made therein without departing from the spirit and scope of the present invention as defined by the following claims. The exemplary embodiments should be considered in a descriptive sense only and not for purposes of limitation.

What is claimed is:

1. A method of providing a video stream which comprises different video stream data for each of a plurality of layers, the method comprising:
receiving from a transmitting apparatus a maximum transmittable layer level determined based on a state of a first network;
receiving from a first receiving terminal a first maximum receivable layer level determined based on a state of a 2ath network;
receiving from a second receiving terminal a second maximum receivable layer level determined based on a state of a 2bth network; and
relaying the video stream using the maximum transmittable layer level, the first maximum receivable layer level and the second maximum receivable layer level.

2. The method of claim 1, wherein upon a condition that the maximum transmittable layer level is equal to or higher than the first maximum receivable layer level and the second maximum receivable layer level, the video stream is relayed to the first receiving terminal at the first maximum receivable layer level and relayed to the second receiving terminal at the second maximum receivable layer level in the relaying of the video stream.

3. The method of claim 1, wherein upon a condition that the maximum transmittable layer level is equal to or higher than the first maximum receivable layer level and lower than the second maximum receivable layer level, the video stream is relayed to the first receiving terminal at the first maximum receivable layer level and relayed to the second receiving terminal at the maximum transmittable layer level in the relaying of the video stream.

4. The method of claim 1, wherein the first network is a network between the transmitting apparatus and a relay apparatus, and the state of the first network is identified using at least one from among packet loss, jitter, and delay in the first network.

5. The method of claim 1, wherein the 2ath network is a network between the first receiving terminal and the relay apparatus, and the 2bth network is a network between the second receiving terminal and the relay apparatus, wherein the state of the 2ath network is identified using at least one from among packet loss, jitter, and delay in the 2ath network, and the state of the 2bth network is identified using at least one from among packet loss, jitter, and delay in the 2bth network.

6. The method of claim 1, wherein the video stream is generated to comprise different video stream data for each of the plurality of layers by using scalable video codec (SVC).

7. The method of claim 1, wherein in the relaying of the video stream, the video stream is relayed using the maximum transmittable layer level, the first maximum receivable layer level, and the second maximum receivable layer level without a filtering process in which a layer for relaying the video stream is selected for each receiving terminal.

8. A system for providing a video stream which comprises different video stream data for each of a plurality of layers, the system comprising:
a relay apparatus which provides a communication channel for each of the layers; and
a transmitting apparatus which transmits to the relay apparatus a maximum transmittable layer level determined based on a state of a first network and transmits the video stream to the relay apparatus,
wherein the relay apparatus comprises:
a receivable layer level receiver configured to receive from a first receiving terminal a first maximum receivable layer level determined based on a state of a 2ath network and receives from a second receiving terminal a second maximum receivable layer level determined based on a state of a 2bth network; and
a video stream relayer configured to relay the video stream using the maximum transmittable layer level, the first maximum receivable layer level and the second maximum receivable layer level.

9. The system of claim 8, wherein the transmitting apparatus obtains information about the first maximum receivable layer level and the second maximum receivable layer level and, upon a condition that a higher level among the first maximum receivable layer level and the second maximum receivable layer level is lower than the maximum transmittable layer level, the transmitting apparatus determines the maximum transmittable layer level to be the higher level and transmits the video stream to the relay apparatus at the maximum transmittable layer level.

10. The system of claim 8, wherein upon a condition that the maximum transmittable layer level is equal to or higher than the first maximum receivable layer level and the second maximum receivable layer level, the relay apparatus relays the video stream to the first receiving terminal at the first maximum receivable layer level and relays the video stream to the second receiving terminal at the second maximum receivable layer level.

11. The system of claim 8, wherein upon a condition that the maximum transmittable layer level is equal to or higher than the first maximum receivable layer level and lower than the second maximum receivable layer level, the relay apparatus relays the video stream to the first receiving terminal at the first maximum receivable layer level and relays the video stream to the second receiving terminal at the maximum transmittable layer level.

12. A relay apparatus for providing a video stream which comprises different video stream data for each of a plurality of layers, the relay apparatus comprising:
a transmittable layer level receiver configured to receive from a transmitting apparatus a maximum transmittable layer level determined based on a state of a first network;
a receivable layer level receiver configured to receive from a first receiving terminal a first maximum receivable layer level determined based on a state of a 2ath network and receives from a second receiving terminal a second maximum receivable layer level determined based on a state of a 2bth network; and
a video stream relayer configured to relay the video stream using the maximum transmittable layer level, the first maximum receivable layer level and the second maximum receivable layer level,
wherein at least one from among the transmittable layer level receiver, the receivable layer level receiver, and the video stream relayer is implemented via a CPU.

13. The relay apparatus of claim 12, wherein upon a condition that the maximum transmittable layer level is equal to or higher than the first maximum receivable layer level and the second maximum receivable layer level, the video stream relayer relays the video stream to the first receiving terminal at the first maximum receivable layer level and relays the video stream to the second receiving terminal at the second maximum receivable layer level.

14. The relay apparatus of claim 12, wherein upon a condition that the maximum transmittable layer level is equal to or higher than the first maximum receivable layer level and lower than the second maximum receivable layer level, the video steam relayer relays the video stream to the first receiving terminal at the first maximum receivable layer level and relays the video stream to the second receiving terminal at the maximum transmittable layer level.

15. The relay apparatus of claim 12, wherein the first network is a network between the transmitting apparatus and the relay apparatus, and the state of the first network is identified using at least one from among packet loss, jitter, and delay in the first network.

16. The relay apparatus of claim 12, wherein the 2ath network is a network between the first receiving terminal and the relay apparatus, and the 2bth network is a network between the second receiving terminal and the relay apparatus, wherein the state of the 2ath network is identified using at least one from among packet loss, jitter, and delay in the 2ath network, and the state of the 2bth network is identified using at least one from among packet loss, jitter, and delay in the 2bth network.
